(19) United States
(12) Patent Application Publication
(10) Pub. No.: US 2020/0064616 A1
(43) Pub. Date: Feb. 27, 2020

(54) SUPER-RESOLUTION, THREE-DIMENSIONAL MICROSCOPE

(71) Applicant: David Markle, Pleasanton, CA (US)

(72) Inventor: David Markle, Pleasanton, CA (US)

(21) Appl. No.: 16/543,550

(22) Filed: Aug. 17, 2019

Related U.S. Application Data
(60) Provisional application No. 62/720,749, filed on Aug. 21, 2018.

(51) Int. Cl. G02B 21/36; G01N 21/64; G02B 21/16; G02B 21/33; G02B 21/06

(52) U.S. Cl. CPC G02B 21/367; G01N 21/64; G02B 21/16; G01N 2201/06113; G02B 21/06; G01N 2201/068; G02B 21/33

(57) ABSTRACT

A system for obtaining a 3-D, super-resolution model of an object in an image space is provided as well as novel and nonobvious components thereof. The system includes a light source that constrains uninhibited activation light to a thin slice through the object, the object having a volume that is perpendicular to an axis of a 2-D super-resolution microscope, a means for providing relative incremental movement between the object and the thin slice of constrained uninhibited activation light, and a means for taking a super resolution picture of each incremental slice resulting from the relative incremental movement between the object and the thin slice, thereby creating a set of voxels from which an accurate 3-D super-resolution model of any fluorescent object contained within the image space can be constructed.

### CROSS-REFERENCE TO RELATED CASES

This application claims priority to U.S. Provisional Patent Application No. 62/720,749, entitled “Super-resolution, 3D Microscope,” by David Markle, filed Aug. 21, 2018, and is related to U.S. patent application Ser. No. 13/871,031, entitled “Apparatus and methods for microscopy having resolution beyond the Abbe limit,” filed Apr. 26, 2013, which has matured into U.S. Pat. No. 9,075,013 to Markle et al., the disclosures of which is hereby incorporated by reference in their entireties.

### BACKGROUND

The invention generally relates to super-resolution three-dimensional (3-D) microscopy. In particular, the invention relates devices and methods that improve the resolution of optical wavelength, 3-D microscopes.

In general, super-resolution microscopy can be achieved through a method that uses a special fluorescent dye. The dye is attached to features to be viewed under a super-resolution microscope. The dye is caused to fluoresce under illumination by light of a first wavelength, called the activation wavelength. The dye is also is inhibited from fluorescing with light of a second wavelength. By creating two, orthogonal sets of interference fringes with the inhibition wavelength, it is possible to pattern a uniform distribution of the activation light into a 2-D array of narrow probes that have dimensions well below the diffraction limit.

One problematic issue associated with this method involves the spacing between the probes. The spacing is limited by the Abbe criterion to the wavelength divided by two times the numerical aperture, and the effective size of the probes depends on the relative levels of the inhibition and excitation intensities as well as the characteristics of the two-color fluorescent material. Because the spacing between the probes is generally much larger than the size of the probes, a number of pictures, each containing a sparse array of pixels, and each corresponding to a slightly different position of the probes, must be combined to yield a complete picture. Because each picture is available electronically, it is relatively easy set a threshold which removes most of the noise between valid pixels.

Although the resultant picture has excellent resolution in the lateral dimensions (X & Y), the resolution in the normal direction (Z) is generally a large multiple of the lateral resolution. If the two interfering inhibition beams in both lateral planes have equal intensities, then the extent of the probes in the focus direction extend over the entire overlapped region. This makes it very difficult to get an accurate 3-D representation of a complicated 3-D object.

Many micro-organisms are quite complicated and have fine appendages that extend well beyond the main body. Very often, these appendages are well below the diffraction limit of visible microscopes, which currently represent the only means of viewing living micro-organisms. Super-resolution visible microscopes are available, which have sufficient resolution laterally, but they suffer from a very large depth-of-focus. As a result, the large depth-of-focus can superimpose the contributions from multiple parts of the micro-organism, and thereby produce an inaccurate 3-D model of the micro-organism.

What is needed is a microscope capable of imaging very thin slices of the micro-organism so that an accurate 3-D representation can be easily obtained.

### SUMMARY

By their very nature super-resolution microscopes obtain a picture in which the depth-of-focus of each pixel is very much longer than the lateral resolution, which makes it very difficult to accurately construct a 3-dimensional model of the object under observation. This invention addresses this issue by limiting the size of each pixel in the focus direction to a size comparable to the resolution in the lateral direction. This is done by generating a very thin, super-resolution slice in the specimen, normal to the microscope axis in which fluorescence is possible and by suppressing fluorescence elsewhere in the object. By taking a series of pictures, each corresponding to a different position of the activated slice in the object, it is possible to obtain an accurate 3-dimensional model of the object.

Thus, the invention provides an apparatus for obtaining a 3-D, super-resolution model of an object in an image space. The apparatus provides a super-resolution microscope having a microscope axis and focused on a 3-D specimen labeled with a fluorescent dye that is fluorescent when illuminated with an activation wavelength and inhibited from fluorescing when illuminated with an inhibition wavelength, the microscope employing a crossed grid of fringes generated from the inhibition wavelength to define a sparse array of super-resolution areas covering the specimen, with an optional activation source optionally used at normal incidence for 2-D imagery. The apparatus may also include a means for generating two or more fringe patterns of inhibition light arranged normal to a microscope axis and having slightly different spatial frequencies so when the patterns of inhibition light are overlapped on the specimen a narrow, uninhibited, super-resolution zone is generated normal to the microscope axis.

The means for generating two or more fringe patterns may do so normal to the microscope axis, by employing a modified Dyson relay, which images ±1 diffraction orders from a grating onto the specimen. This may be achieved by employing a block of glass containing a grating at one end, an opaque element in the block of glass to block the zero order from the laser illuminated grating, and polished sides to redirect the ±1 orders from the grating to an output end of the block, where the diffraction orders overlap, thereby generating inhibition light fringes throughout the volume of the specimen.

Where activation light is supplied by one or more laser beams, the beams are focused into a middle image area with an NA that is large enough to minimize widths of the beams in a Z-direction and small enough to keep beam sizes approximately equal over a lateral dimension of the image field.

Fringe patterns of inhibition light arranged normal to the microscope axis are typically generated by illuminating a grating with monochromatic, collimated light and causing the resultant ±1 diffraction orders to be overlapped in the image field. In such a case, a laser serves as a source of monochromatic, collimated light.

When a modified Dyson system is present, the system includes a plane parallel plate of glass having a higher index of refraction than the glass used for the Dyson lens.

In addition, fringe patterns may be generated by overlapping grating orders that are described by sine squared functions, and a frequency ratio defined between first and second frequencies is about 1:1.2, and a frequency ratio defined between first and third frequencies is about 1:1.0655.

In a particular embodiment of the invention, the specimen is positioned on top of a glass pedestal, which contains grating patterns responsible for generating the interference patterns projected at normal incidence to the microscope axis. In addition, the specimen and the grating patterns may be immersed in a liquid. The specimen may be positioned by moving the liquid in which the specimen is immersed.

The invention also provides for a system for obtaining a 3-D, super-resolution model of an object in an image space. The system comprises: an activation light source that employs conventional means to illuminate a thin slice through the object, that is perpendicular to an axis of a 2-D super-resolution microscope; two or more inhibition light fringe patterns that overlap each other and the thin slice of activation light to create an activation source having super-resolution dimensions and which serve to inhibit any activation light existing outside of the super-resolution dimensioned slice; a means for providing relative incremental movement between the object and the thin slice of constrained uninhibited activation light; and a means for taking a super resolution picture of each incremental slice resulting from the relative incremental movement between the object and the thin slice, thereby creating a set of voxels from which an accurate 3-D super-resolution model of any fluorescent object contained within the image space can be constructed.

The relative incremental movement providing means may move the object relative to the thin slice of constrained uninhibited light, e.g., via movement of the object via a liquid, i.e., a substantially incompressible fluid such as liquid water.

The invention may be used to observe a live or living specimen with an optical resolution of 200 nm or less. The specimen may include one or more fluorescent dyes.

In a further embodiment, a system for positioning and incrementally moving an object of interest for 3-D microscopy is provided, comprising: a 3-D field located in a liquid surrounding the object of interest; and a means for displacing liquid surrounding the object of interest in a manner that allows for positioning and incrementally moving the object of interest.

In still another embodiment, an optical system is provided for generating a very regular, high spatial frequency, fringe pattern over a large volume containing a liquid by imaging a grating, with an optical system, comprising a plate of high index material, a lens of low index material, and a spherical mirror.

Also envisioned is a microscope apparatus for creating a very thin slice of activation space spanning the lateral field of a 2-D super-resolution microscope, but having a focal depth equal to only one super-resolution element. The microscope apparatus includes a means for superimposing 2 or more inhibition interference patterns having slightly different spatial frequencies and fringes oriented normal to the microscope axis with a similarly-oriented, narrow-beam of activation light.

### BRIEF DESCRIPTION OF THE DRAWINGS

FIG. 1 depicts the super-resolution principle by plotting the intensity distribution of a single pixel image relative to that of an inhibition interference pattern, thereby obtaining the difference therebetween.

FIG. 2 depicts the effective activation intensity profile for various inhibition to activation intensity ratios.

FIG. 3 depicts the relative orientation of the axes of various optical systems.

FIG. 4 depicts alternative means of generating interference fringes.

FIG. 5 depicts an exemplary Dyson optical system.

FIG. 6 depicts the refractive part of the Dyson optical system shown in FIG. 5

FIG. 7 depicts in vertical sectional view that illustrates one diffraction order.

FIG. 8 depicts in vertical sectional view the object and image areas of a 3-D microscope.

FIG. 9 depicts a horizontal cross-sectional view of a 3-D microscope setup.

FIG. 10 depicts intensity distribution generated by two overlapping fringe patterns.

FIG. 11 depicts intensity distribution generated by three overlapping fringe patterns.

### DETAILED DESCRIPTION

### Overview and Definitions

Before describing the present invention in detail, it is to be understood that the terminology used herein is for the purpose of describing particular embodiments only, and is not intended to be limiting.

In addition, as used in this specification and the appended claims, the singular article forms “a,” “an,” and “the” include both singular and plural referents unless the context clearly dictates otherwise. Thus, for example, reference to “a microscope” includes a plurality of microscopes as well as a single microscope, reference to “a pattern” includes a single pattern as well as a collection of patterns, and the like.

In this specification and in the claims that follow, reference will be made to a number of terms that shall be defined to have the following meanings, unless the context in which they are employed clearly indicates otherwise:

The term “NA” is used in its ordinary optics sense and refers to the numerical aperture of an optical system, i.e., a dimensionless number that characterizes the maximum angle over which the system can accept or emit light

“Optical,” “optically” and the like are used in their ordinary sense and refer to matters that relate to ultraviolet, visible and infrared parts of the electromagnetic spectrum. Typically, but not necessarily, the visible part of the electromagnetic spectrum is recognized as corresponding to a wavelength range of about 390 nm to about 700 nm.

“Optional” or “optionally” means that the subsequently described circumstance may or may not occur, so that the description includes instances where the circumstance occurs and instances where it does not.

Super-resolution as applied to the field of microscopy refers to achieving a resolution beyond the diffraction limit as defined by Ernst Abbe, who defined the smallest object that might be resolved by a microscope as being equal to the wavelength of light divided by 2 times the numerical aperture. Only fairly recently has a way been found around this fundamental limit. This involves staining the object of interest with a fluorescent dye that can be caused to fluoresce when exposed to one wavelength and caused to stop fluorescing when exposed to a second wavelength. By patterning the inhibition radiation so that fluorescence is possible only in a very sparse pattern of tiny areas and by taking many pictures each having a slightly different position on the object it is possible to construct a complete picture of the object having a resolution well beyond the Abbe limit.

Thus, “super-resolution” as applied to the field of microscopy refers to the ability of a microscope device, system, and/or apparatus to resolve object features smaller than the diffraction limit described by Ernst Abbe. Typically, the optical resolution of super-resolution systems is about 200 nm or less. In some cases, the resolution can be as small as 10 nm or less.

3-D Optical Microscopy

The invention, then, pertains to super-resolution 3-D optical microscopy. Such microscopy makes use of two-dimensional (2-D) pictures (in the X and Y directions) obtained using a high NA microscope objective, which images multiple pictures, each being a sparse array of regularly spaced pixels that constitute a small portion of the whole picture, Combining each of the sparse pictures into a single picture yields a super-resolution picture. The inhibition fringe pattern that defines the sparse array of super-resolution pixels can be projected through the microscope objective, or it can be incident on the specimen from the opposite direction. Each sparse picture corresponds to a slightly different lateral position of the inhibition array on the object. The inventive technique, to limit the resolution in the focus or Z-direction, is compatible with either configuration.

Whereas 2-D pictures can be obtained by illuminating the object with excitation radiation introduced along the Z-axis, in some situations the best arrangement for a 3-D picture is to illuminate the object normal to the Z-axis with a narrow sheet of excitation radiation, limited in width by the size of the object in the X and Y-directions.

The invention thus also provides a method for improving the resolution in the third dimension so that an accurate 3-D model of a complicated object can be obtained. For example, excitation illumination can be used to generate a relatively narrow band of light across a plane in the volume of interest and normal to the Z-axis, which is close to the diffraction limit in width, and this band can be narrowed further to super-resolution dimensions by also introducing inhibition fringe patterns running normal to the X-axis, which also serves to narrow the width of the excitation band. This allows each super-resolution, 2-D picture to be confined to a narrow zone through the volume of interest. Incrementally moving the object of interest with respect to the narrow band of illumination generates a series of super-resolution pictures, each picture corresponding to an incrementally different section through the object of interest. Thus, the entire volume of interest can be divided into voxels, which are approximately spherical in shape, and which provide a very accurate description of any 3-D object no matter how convoluted its shape happens to be.

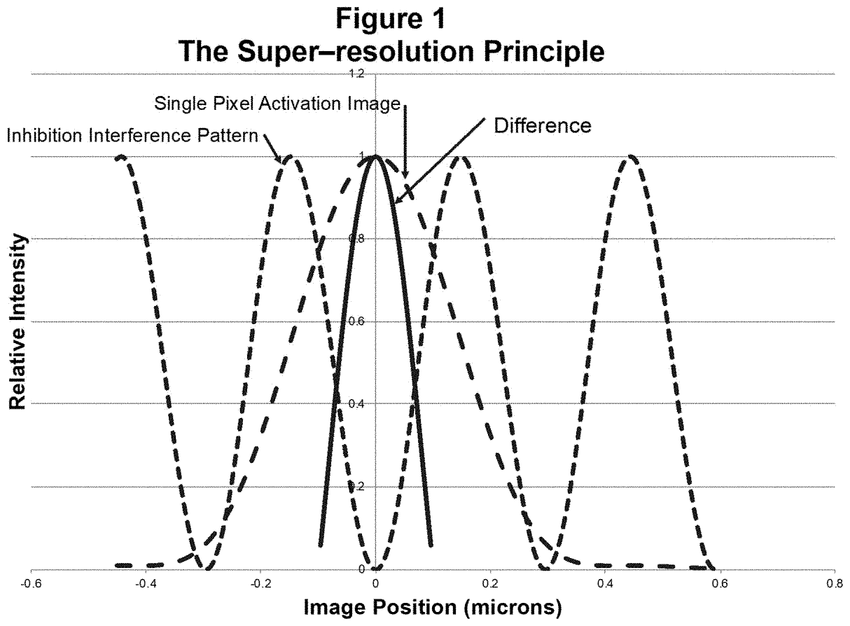

FIG. 1 compares the intensity profile of a diffraction image from a small feature (single pixel) in an object with a 0.858 NA objective examined at a wavelength of 405 nm with the highest possible frequency fringe pattern that can be produced with the same objective at a wavelength at 532 nm. It is immediately obvious that the single frequency interference pattern has a higher resolution than the diffraction image, which contains a broad range of spatial frequencies.

The following is very simplified description of the physics underlying super-resolution. Assuming that a Watt of activation light at 405 nm is equally effective at stimulating fluorescence as a Watt of light at 532 nm at inhibiting fluorescence, then when the two intensities are equal, nothing should be stimulated to fluoresce. And the amount of fluorescence should be proportional to the intensity of the stimulated light minus the intensity of the inhibition light. The result is illustrated in FIG. 1. The single pixel image is assumed to be generated by activation light, which stimulates fluorescence, and the periodic interference pattern is assumed to be light, which inhibits fluorescence. The bold difference curve is almost one third as wide as the single pixel image indicating a potential gain in resolution of nearly 3.

This is only a first order approximation to what really happens—a better approximation would involve molecular cross-sections and time constants, which can vary the inhibition to excitation ratio in either direction. Very little data on molecular cross-sections and time constants is currently available, but current research programs seem likely to change this situation in the near term.

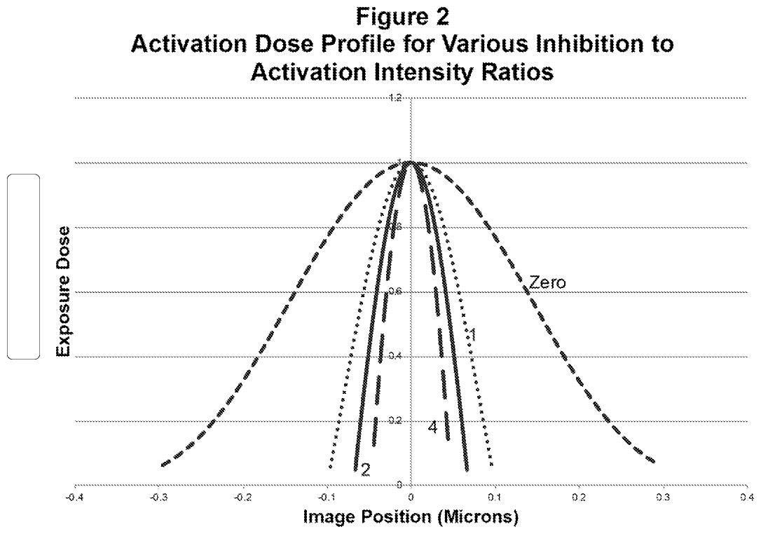

It is possible to increase resolution by decreasing the size of the small holes where fluorescence is possible, by increasing the ratio of the inhibition intensity to the activation intensity. This is illustrated in FIG. 2, which shows the resultant probe width for inhibition to activation intensity ratios of zero, 1, 2, and 4. For ratios above one, the probe width decreases to 70.7%, (1/√2), each time the intensity ratio doubles. This is because the shape of a sine-squared curve near zero is approximated by a parabolic curve.

To a first approximation the width of a super-resolution probe can be predicted using the following equation:

Probe Width=((0.2 microns)(Intensity of inhibition/Intensity of excitation))^{0.5} (1)

Other assumptions built into this equation are an excitation wavelength of 405 nm, an inhibition wavelength of 532 nm, and an NA of 0.858. However, the general principle of this equation should also hold for other excitation wavelengths, other inhibition wavelengths, and other NA as well.

Shaping the Activation Illumination

Generally, it is desirable to constrain the excitation illumination to a narrow band passing through the volume of interest, and normal to the Z-axis, so that there is no possibility of fluorescent material located outside of the limited inhibition zone contributing to the picture.

The volume of interest is defined as a rectangular area having a given length and width, in the X and Y axis, and which is normal to a main axis, Z, that contains the optical axis of a microscope that views the orthogonal fringe patterns superimposed on the rectangular area. The third dimension, Z, will be called the depth or focus dimension, and it is normal to this dimension that the narrow slice of uninhibited volume is formed by focusing a narrow beam of activating light originating from one or more objectives, each having an axis at right angles to the main Z-axis. The output from the objective supplying excitation illumination can be focused into a small beam roughly λ/2NA in width and λ/NA² in length, where λ is the wavelength and NA the numerical aperture of the beam. The NA can be chosen so that the length of the beam remaining in good focus is approximately equal to the length of the volume of interest and the beam can be broadened to span the width of the volume of interest, possibly by introducing a little astigmatism. This arrangement provides relatively good illumination uniformity at a given depth and over the length and width of the volume of interest.

However, the dimension of the beam in the depth direction is roughly λ/2NA. This dimension may be narrowed to the size of the super-resolution elements obtained in the other dimensions.

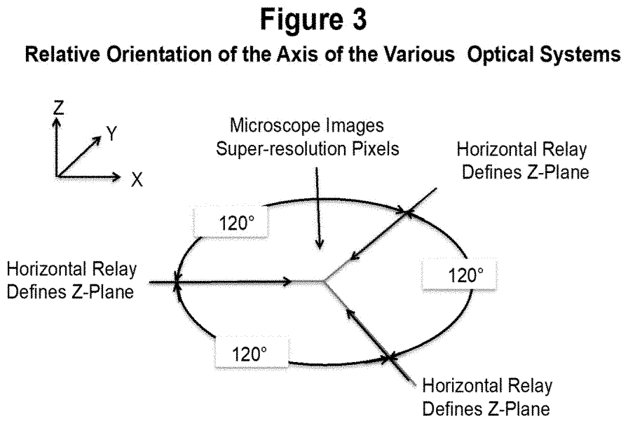

A possible arrangement showing one of the many possible relative positions of the microscope axis and the axis of the relays that serve to narrow the activation plane in the Z-direction is shown in FIG. 3. The beams generating the crossed fringe pattern can be incident from the top or bottom, and the microscope examining the resultant fluorescent pattern can be collinear with the crossed fringe generator or directly opposed. In this case, the main axis is oriented vertically and faces upward to offer access to the sample volume located where the centers of the 4 images of the 4 optical systems converge. Each of the 3 horizontal axes shown in the Figure contains an objective that images an interference pattern formed from inhibition radiation and each objective generates a slightly different spatial frequency.

Narrowing the Activation Zone

There are at least two rather different methods for generating a periodic fringe pattern. Both involve superimposing collimated beams having equal and opposite incidence angles. Although it is not mandatory, both methods may involve using a laser source, because of the much higher brightness of laser sources. In both cases a single-mode, single-wavelength laser is preferred because this generally yields a greater depth of focus and sharper fringes. A single-mode, single-wavelength laser is preferred because there are inevitably appreciable path differences between the interfering beams in the final image and a single mode laser increases the depth-of-focus. The two collimated beams interfere wherever they overlap thereby creating a very high contrast pattern of horizontal fringes. Because there is no zero-order present in the grating image, the resulting intensity profile follows a sine-squared function having a period that is half that of the object grating.

The interference pattern contrast depends upon the intensity of the interfering beams being equal. Since the beams overlap over a considerable area and are incident with a large angle between them, the only way to achieve high contrast is to make the intensity profile of the beams flat and constant over the desired interference volume. Typically, a single mode laser beam has a Gaussian profile, which is difficult to efficiently shape into a beam with a flat intensity profile over an extended region.

However, there are optical systems designed to broaden the center portion and tuck in the periphery so good uniformity can be achieved over a considerable area, albeit with some loss of light.

In this special case the depth-of-focus doesn't follow the usual λ/NA² relationship because the zero order is missing.

Narrowing the excitation zone is done by projecting two or more fringe patterns formed using inhibition light through the volume of interest and at right angles to the main axis.

The fringe patterns have different spatial frequencies and combine to generate a thin slice, normal to the Z-axis, where the inhibition intensity projected through the volume of interest reaches zero and an extended zone either side of this slice where the inhibition intensity is sufficient to squelch any fluorescence. The width of the extended zone is ideally made to exceed the dimension of the excitation beam in the depth direction, thus ensuring that extraneous dyed material outside the volume of interest will not contribute to the desired picture.

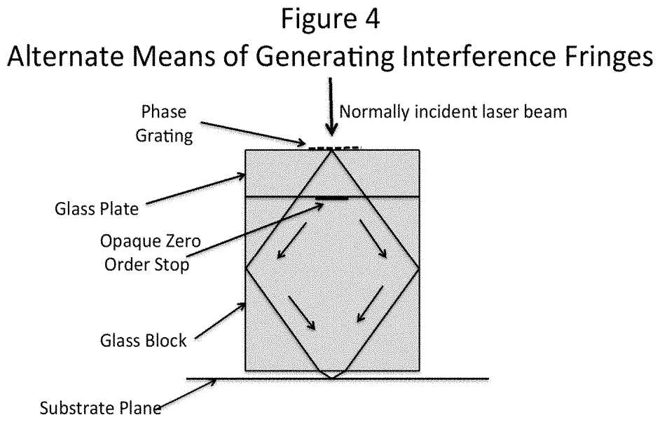

One possibility for generating a fringe pattern is shown in FIG. 4. In this case a collimated laser beam is normally incident on a phase grating etched into a fused silica mask. The phase grating directs most of the incident light into the +1 and −1 diffraction orders. Any residual zero order light is blocked by an opaque stop located on the opposite side of the glass plate containing the grating. The diffracted orders are totally internally reflected from the sides of the glass block located below plate containing the grating and are arranged to overlap just below the block by careful manipulation of the dimensions of this glass block. The two glass components can be made of any type of glass having good transmission properties for the laser wavelength, and a high enough index of refraction to totally reflect the diffracted light incident on the side of the block. However fused silica is generally used for mask manufacture and making the second glass component of the same material eliminates problems that would otherwise arise from differences in the coefficient of thermal expansion. One of the problems with this simple arrangement is that it is difficult to get good beam uniformity at both the object plane (the grating) and at the image plane (the substrate). Collimated laser beams tend toward a Gaussian intensity profile as they progress through space and a uniform intensity profile is usually constrained to a limited depth of field.

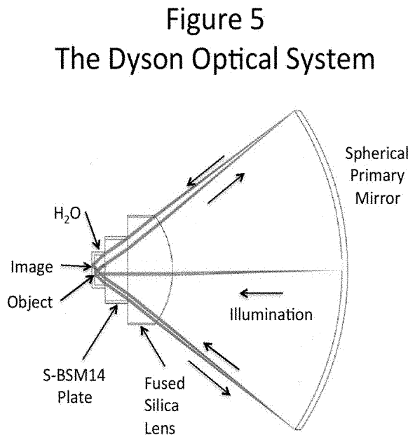

An alternate way of generating the horizontal interference patterns in illustrated in FIG. 5. This system was discovered by an English physicist named Dyson who employed it to rule gratings. Dyson's system consisted only of a thick, plano-convex lens and a spherical mirror. The curved surface of the lens and the mirror were concentric spherical surfaces and their centers of curvature were located on the plano surface of the thick lens, along with the object and image planes. Thus, there was no working distance for either the object or image planes.

The system shown in FIG. 5 is a slightly modified Dyson system. By adding a plate of relatively high index S-BSM glass a practical working distance is obtained. In this case the object and image planes are located in water—the preferred medium for live biology specimens. Unlike most systems, which are designed to operate over a range of cone angles, typically from zero to the limiting NA, this system is optimized for operation at only the maximum NA. The optimization included setting stringent limits for the variation in the output angle with field position.

In FIG. 5 the laser beam enters the Dyson system through a hole in the middle of the mirror and is focused to a diffraction-limited spot near the pupil of the Dyson system, which is very close to the vertex of the primary mirror. After going through focus the beam is directed to the lower half of the fused silica lens, which collimates the beam and directs it through the S-BSM plate and onto a reflective phase grating immersed in water. The zero-order reflected from the phase grating has almost no intensity and what little remains is returned to the laser. Most of the reflected light is concentrated into the +1 and −1 diffraction orders. These orders are focused onto two small spots on opposite edges of the primary, where they are reflected back to the lens. After passing through the lens the light from both orders is collimated and the two beams are superimposed on the object plane on the opposite side of the optical axis from the input beam. The resultant grating image has exactly twice the period of the object grating because the zero order has been eliminated. This drawing was generated by an optical design program called Zemax, which makes the primary mirror appear to be very thin. In practice, the mirror would be much thicker.

The parameters of the design shown in FIG. 5 are listed in the Table below:

Table of Dyson Lens Parameters

| Surface | Radius | Thickness | Glass | Diameter |
|---|---|---|---|---|
| Object | Infinity | 0.636 | Water | 0.62 |
| Diffraction | | | | |
| Grating | | | | |
| 1 | Infinity | 1.36 | S-BSM14 | 1.687 |
| 2 | Infinity | 2.718 | SUPRASIL | 3.406 |
| 3 | −4.741 | 10.261 | Air | 5.873 |
| 4 | −15 | −10.261 | MIRROR | 17.627 |
| 5 | −4.741 | −2.718 | SUPRASIL | 6.062 |
| 6 | Infinity | −1.36 | S-BSM14 | 3.706 |
| 7 | Infinity | −0.809 | Water | 1.987 |
| Image | Infinity | | | 0.629 |

The radius, thickness, and diameter values in the table are in millimeters. Suprasil is a commercially-available, high-quality, fused silica glass. Note that this entire optical system would fit comfortably in a one-inch cube.

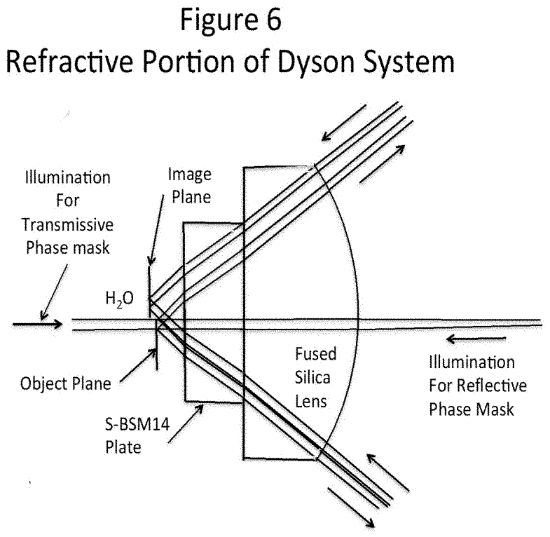

A magnified picture of the region around the object and image planes is shown in FIG. 6. This example shows how the object can be either a transmitting or a reflective phase mask simply by reversing the direction of the illuminating beam.

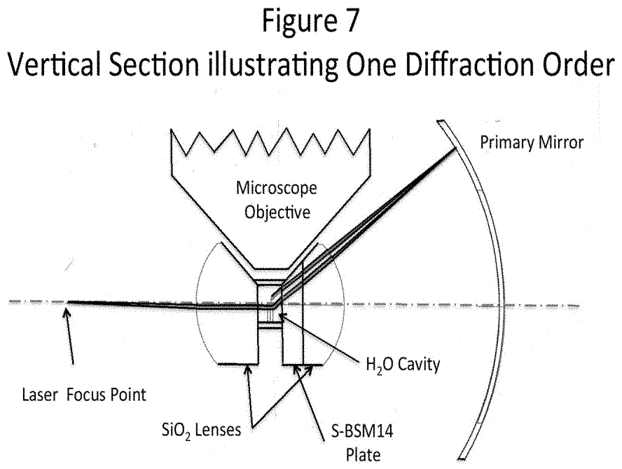

FIG. 7 illustrates the water cavity containing the object specimen, the position of the microscope objective that extracts a 2-dimensional super resolution picture of the specimen by superimposing a 2-dimensional inhibition grid on the specimen, and one of the three relays that together generate a single, narrow, horizontal plane through the object, which is not inhibited. In this case the phase grating is assumed to be a transmission grating, which is etched into the surface of a small glass pedestal having a hexagonal cross-section and slightly different phase grating patterns etched into three of the six vertical surfaces. The small volume containing the specimen is located just above the center of the hexagonal pedestal. In this Figure only one diffraction order is shown. The S-BSM plate and the fused silica lens are chamfered at 45° to provide access to both the high NA microscope objective and the high NA Dyson system. In this case the maximum angle of the rays generated by the horizontal relays in the water is 40° off-axis. A similar condition applies to the rays forming the inhibition fringes generated in the microscope objective. Since the index of water is about 1.335 in the middle of the visible spectrum, where the inhibition wavelength is likely to be located, the relevant NA is approximately:

NA=1.335 sin(40°)=0.858

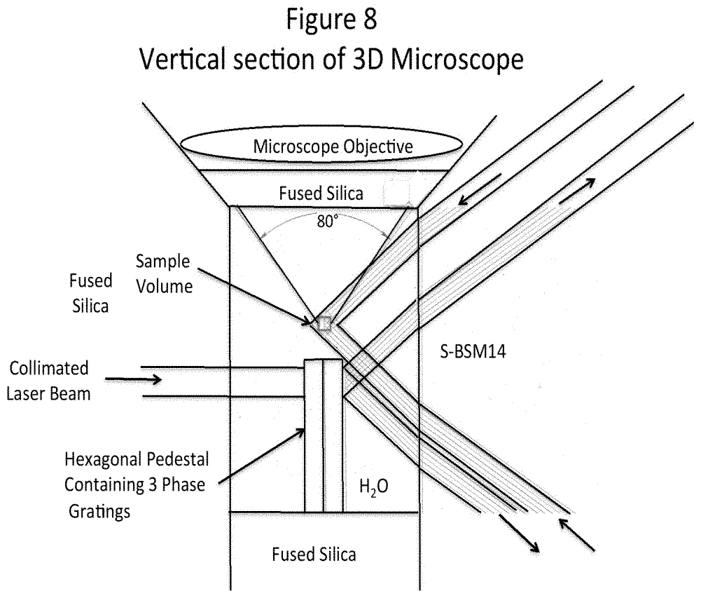

A further enlargement of the water cavity and its surrounds is shown in FIG. 8. In this view the sample volume is easily seen and is entirely contained in the image area where the diffraction orders overlap to create the single horizontal plane containing no inhibition light. In this example the collimated beam of inhibition light passes through the hexagonal pedestal to the transmission phase grating on the far side to generate the diffraction orders, which are reimaged onto the sample volume. The sample volume might be a 62-micron cube and the surrounding volume of water is contained in a hexagonal shaped volume 1.618 mm across and 2.35 mm tall. The radius of the primary mirror is 15 mm and the diameter about 22 mm.

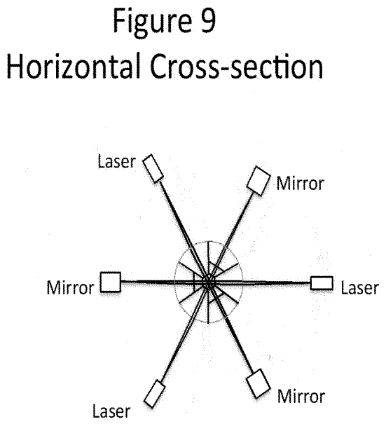

A cross-section through the centers of the three relays is shown in FIG. 9. Each of the three paths is identical. The inhibition laser is imaged at a point on the optical axis on one side about the same distance away from the lens as the mirror is on the other side. The beam then proceeds through a thick lens and into the water cavity. The collimated beam passes through the hexagonal pedestal, which has a transmitting phase grating on the far side. Both diffracted orders from the phase grating proceed on through the water cavity to the S-BSM14 plate, the Dyson lens and the primary mirror. Note that the refractive path is not symmetrical. The flat S-BSM14 plate serves no useful role in improving the collimation of the laser beam on the input side. However, it does serve a useful purpose once the diffraction beams are generated in yielding a useful working distance and in keeping the 2 beams, which interfere at the object plane, well collimated.

Excitation Illumination

One possibility for a source for the excitation illumination is a laser that may have multiple longitudinal modes resulting in several wavelengths over a narrow spectral band. An example might be a high power GaN laser, which operates typically in a band about 2-3 nanometers wide in the 403 nm region, and which can have an output power of 0.5 to 1.5 Watts. The Nichia NDB711E Blue Laser Diode has an output beam with a 10° angular spread in one plane and a 25° angular spread in the other plane. Assuming the 10° angular spread is primarily due to diffraction, the diode aperture size is given by:

Aperture size=λ/2NA=0.403 μm/2 sin(5°)=2.31 μm

Excitation Illumination Example:

In this example, an activation wavelength of 405 nm is used. The activation beam is associated with a NA² equal to λ/DoF (0.403 microns/62 microns=0.0065). Accordingly, the NA is equal to 0.0806.

The size in Z direction is equal to λ/2NA, which translates to ±1.25 microns.

A beam this size could be obtained by simply reimaging the Nichia Diode beam with a magnification of 2.5/2.31, or 1.082. This would increase the 2.31 μm size calculated at the diode to 2.5 μm. Spanning the 62 μm width of the sample could be done simply by introducing some astigmatism in the optical system that reimages the diode onto the sample volume. In fact, as many diodes as needed could be imaged onto the sample volume since the required NA of the activation imaging system is quite modest and the sample can be illuminated from numerous points in the X-Y plane spread across the center plane of the sample volume.

Inhibition Illumination

The volume of interest is really determined by the super-resolution target and the number of pixels desired in the final composite picture. In this example, the super-resolution goal is 1/10 the size of the inhibition fringe spacing (0.310 microns/10=0.031 microns) and the resultant picture size is 2000 by 2000 pixels, which is about all the pixels that can be shown on a high-resolution monitor.

Inhibition Fringe Example

In this example, an inhibition wavelength of 532 nm is used. The index of water at 532 nm is 1.335. The NA is equal to 1.335 sin(40°, which equals 0.858. The fringe spacing is equal to λ/2NA (0.532/(2×0.858) or 0.310 microns). The volume of interest is 62 by 62 by 62 microns, which is equal to 200 by 200 by 200 fringes, which is equal to 500 by 500 camera pixels by 200 pictures (considerable oversampling in the X-Y plane).

Increasing the resolution by a factor of 10 requires that the inhibition intensity is substantially higher than the activation intensity. The ratio, R, of the two intensities is very approximately given by equation (1).

Oversampling each individual sparse picture on the microscope detector by using a high microscope magnification ratio and a camera detector array that has more pixels than is warranted by the information content in the picture, eliminates any need to reposition the image on the camera as the fringe pattern is moved. The raw data from the camera can be used to locate the position of each picture element defined by the black holes in the inhibition interference pattern, and it is possible to predict the peak intensity of the fluorescence from each black hole incident on the camera detector array, which is typically spread over several detectors and the gaps between them.

Turning Off Every Z-Slice but One

In the general case where a substantial gain in resolution is required, the relative intensities of the inhibition wavelength to the activation wavelength is weighted strongly in favor of the inhibition wavelength so that only the activation energy in the very bottom of the black hole between the crossed inhibition fringes is effective in image formation. For example, assuming that the activation and inhibition wavelengths are equally effective in activating or deactivating the fluorescent molecules, then a gain of 10 in resolution would require that the peak inhibition intensity is 41.6 times higher than the excitation intensity.

If it is imagined that the volume of interest is divided into a number of equally thick slices normal to the Z-axis, then the X-Y picture details from a single slice can be obtained by arranging it so all the other slices have an inhibition intensity above some safe level such as 5% of the peak inhibition intensity. This can be done by isolating the activation energy to as few slices as diffraction considerations will allow, and then trimming it with multiple inhibition fringe patterns of different spatial frequencies, which inhibit every part of the activation beam with the exception of the one slice from which information is desired.

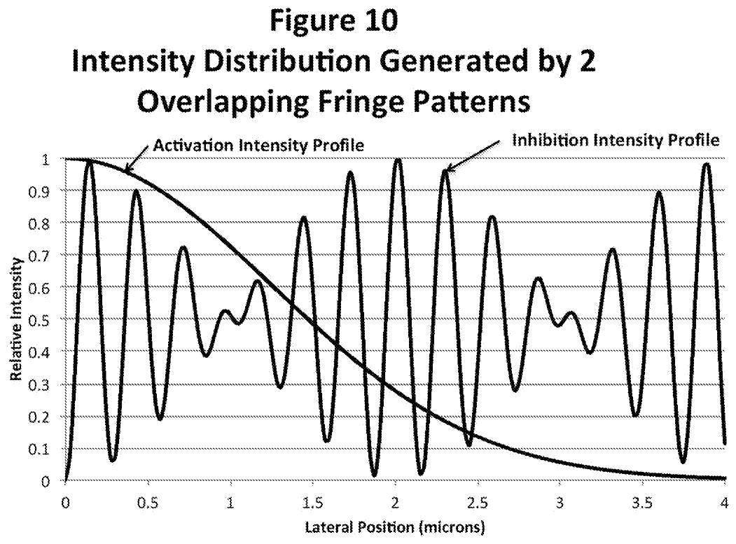

An example of the intensity profile possible by combining 2 sets of fringes is shown in FIG. 10. In this case a thin uninhibited slice about 5 microns wide (total width) is generated by focusing a diffraction-limited activation laser beam into the middle of the sample volume with an NA of about 0.08 and a wavelength of 405 nm. This beam does not change in size appreciably throughout the 62 micron width of the sample volume. The inhibition intensity profile near the zero-lateral position in FIG. 6 is sufficient to squeeze the activation beam profile down to a full width of about 31 nm. Also, the next minimum at 0.286 microns is 0.0495 of the peak intensity, which is probably just sufficient to suppress fluorescence in this region. However, at distances 1.9 and 2.15, microns away from the center there are much lower minimums that probably would not be sufficient to suppress fluorescence and the relative intensity of the fluorescence stimulating beam is still about 25% in this region. This is unacceptable. The spacing of the first set of fringes is the minimum allowed by the available NA and wavelength. The spacing of the second set of fringes is determined by the requirement that the second minimum be at least 5% of the maximum inhibition intensity. Any increase in the height of the second minimum serves to bring the next minimum that falls below 5% closer to the beam center. In this case therefore there is no possibility of employing 2 fringe patterns; a third fringe pattern is mandatory.

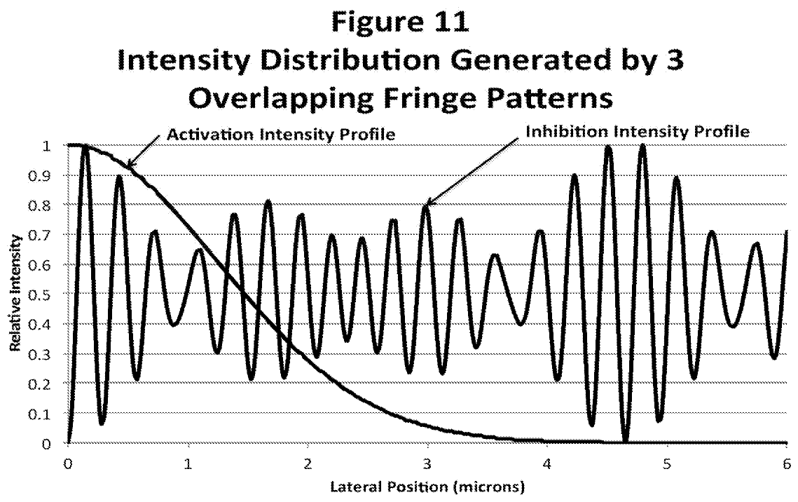

An intensity profile obtained by adding the intensities of 3 different sets of fringes, each with a different spacing, is shown in FIG. 11. The formula used to derive this graphic is shown below:

I=((sin(10.1334x))²+(sin(12.16x))²+(sin(10.797x))²)/2.940527

where x is the lateral position and all angles are in radians.

As before, the first coefficient of x, k₁=10.1334, is determined by the available NA and the inhibition wavelength:

k₁=2πNA/λ=2π(0.858)/(0.532)=10.1334

As before, the first coefficient of x is determined by the NA and the inhibition wavelength. There is some overlap in the effects generated by the other coefficients, but the second coefficient is chiefly responsible to the height of the first minimum past zero and this is 0.057 at x=0.283. The third coefficient is chiefly responsible for the location of the first minimum that falls below the 5% level. In this case the minimum is located at 4.65 microns where the fluorescence stimulating intensity is less than 0.001 of the peak intensity. Thus, all the requirements for generating an isolated, narrow uninhibited zone passing through the middle of the specimen can be achieved with three sets of fringes in this case.

If the desired picture volume had been one-quarter of the size, then the NA of the excitation beam would be twice as large, making the beam waist half as big, and the possibility of using only two sets of fringes quite viable.

Scanning the Object Through the Activation Zone

Since the object may be immersed in liquid, one way of moving the object vertically through the narrow zone of uninhibited activation light is to add liquid at one end of the column and remove it from the other. It should also be possible to laterally shift the object laterally in the column by adding and removing liquid from the column at positions level with the object being studied. There is lots of available room near the mid-plane of the object because the NA of the beams in this direction are quite small.

It is to be understood that, while the invention has been described in conjunction with the preferred specific embodiments thereof, the foregoing description merely illustrates and does not limit the scope of the invention.

In addition, numerous alternatives and equivalents exist which do not depart from the invention set forth above. For example, the inventive apparatus may be constructed to contain or exclude specific features and components according to the intended use of the apparatus, and any particular embodiment of the invention, e.g., those depicted in any drawing herein, may be modified to include or exclude element of other embodiments. Alternatively, stated, different features of the invention described above may be combined in different ways. Other aspects, advantages, and modifications within the scope of the invention will be apparent to those skilled in the art to which the invention pertains.

All patent applications, patents, and publications mentioned herein are incorporated by reference to an extent not inconsistent with the above disclosure.

What is claimed is:

1. An apparatus for obtaining a 3-D, super-resolution model of an object in an image space, comprising:
a super-resolution microscope having a microscope axis and focused on a 3-D specimen labeled with a fluorescent dye that is fluorescent when illuminated with an activation wavelength and inhibited from fluorescing when illuminated with an inhibition wavelength, the microscope employing a crossed grid of fringes generated from the inhibition wavelength to define a sparse array of super-resolution areas covering the specimen, with an optional activation source optionally used at normal incidence for 2-D imagery; and
a means for generating two or more fringe patterns of inhibition light arranged normal to a microscope axis and having slightly different spatial frequencies so when the patterns of inhibition light are overlapped on the specimen a narrow, uninhibited, super-resolution zone is generated normal to the microscope axis.

2. The apparatus of claim 1, wherein the means for generating two or more fringe patterns does so normal to the microscope axis, by employing a modified Dyson relay, which images ±1 diffraction orders from a grating onto the specimen

3. The apparatus of claim 1 wherein the means of generating each of the two or more fringe patterns employs a block of glass containing a grating at one end, an opaque element in the block of glass to block the zero order from the laser illuminated grating, and polished sides to redirect the ±1 orders from the grating to an output end of the block, where the diffraction orders overlap, thereby generating inhibition light fringes throughout the volume of the specimen.

4. The apparatus of claim 1, where activation light is supplied by one or more laser beams, which are focused into a middle image area with an NA that is large enough to minimize widths of the beams in a Z-direction and small enough to keep beam sizes approximately equal over a lateral dimension of the image field.

5. The apparatus of claim 1, wherein fringe patterns of inhibition light arranged normal to the microscope axis are generated by illuminating a grating with monochromatic, collimated light and causing the resultant ±1 diffraction orders to be overlapped in the image field.

6. The apparatus of claim 5, wherein a laser serves as a source of monochromatic, collimated light.

7. The apparatus of claim 2, wherein a modified Dyson system is present that includes a plane parallel plate of glass having a higher index of refraction than the glass used for the Dyson lens.

8. The apparatus of claim 1, wherein fringe patterns generated by overlapping grating orders are described by sine squared functions, and a frequency ratio defined between first and second frequencies is about 1:1.2, and a frequency ratio defined between first and third frequencies is about 1:1.0655

9. The apparatus of claim 1, wherein the specimen is positioned on top of a glass pedestal, which contains grating patterns responsible for generating the interference patterns projected at normal incidence to the microscope axis.

10. The apparatus of claim 1 wherein the specimen and the grating patterns are immersed in a liquid.

11. The apparatus of claim 10 wherein the specimen is positioned by moving the liquid in which the specimen is immersed.

12. A system for obtaining a 3-D, super-resolution model of an object in an image space, comprising:
an activation light source that employs conventional means to illuminate a thin slice through the object, that is perpendicular to an axis of a 2-D super-resolution microscope;
two or more inhibition light fringe patterns that overlap each other and the thin slice of activation light to create an activation source having super-resolution dimensions and which serve to inhibit any activation light existing outside of the super-resolution dimensioned slice.
a means for providing relative incremental movement between the object and the thin slice of constrained uninhibited activation light; and
a means for taking a super resolution picture of each incremental slice resulting from the relative incremental movement between the object and the thin slice, thereby creating a set of voxels from which an accurate 3-D super-resolution model of any fluorescent object contained within the image space can be constructed.

13. The system of claim 12, wherein the relative incremental movement providing means moves the object relative to the thin slice of constrained uninhibited light.

14. The system of claim 13, wherein the incremental movement providing means moves the object via a liquid.

15. The system of claim 14, wherein the liquid comprises water.

16. The system of claim 12, wherein the object is alive or living.

17. The system of claim 12, wherein the system has an optical resolution of 200 nm or less.

18. An optical system for generating a very regular, high spatial frequency, fringe pattern over a large volume containing a liquid by imaging a grating, comprising,
a plate of high index material,
a lens of low index material, and
a spherical mirror.
